(19) United States
(12) Patent Application Publication
(10) Pub. No.: US 2007/0016895 A1
(43) Pub. Date: Jan. 18, 2007

(54) Selective omission of endian translation to enhance emulator performance

(75) Inventor: Victor Tan, Kirkland, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/182,696

(22) Filed: Jul. 15, 2005

(51) Int. Cl. G06F 9/45

(52) U.S. Cl. 717/136

(57) ABSTRACT

A JIT binary translator examines code to determine if a conversion from big-endian to little-endian can be omitted. For example, the conversion may be omitted when data is merely being loaded and stored. The conversion from big-endian to little-endian may also be omitted when storing certain constructs and numbers. A third example is loading of floating point values. If a conversion from big-endian to little-endian is performed, this could result in four instructions in PowerPC, seven if double precision. However, if floating point values are access consistently as big-endian, the result is only one PowerPC instruction. Optimizations, such as these result in a tighter emulated binary.

### BACKGROUND OF THE INVENTION

Computers include general purpose central processing units (CPUs) or “processors” that are designed to execute a specific set of system instructions. A group of processors that have similar architecture or design specifications may be considered to be members of the same processor family. Examples of current processor families include the Intel 80X86 processor family, manufactured by Intel Corporation of Sunnyvale, Calif.; and the PowerPC processor family, which is manufactured by International Business Machines (IBM) or Motorola, Inc. Although a group of processors may be in the same family because of their similar architecture and design considerations, processors may vary widely within a family according to their clock speed and other performance parameters.

Each family of microprocessors executes instructions that are unique to the processor family. The collective set of instructions that a processor or family of processors can execute is known as the processor's instruction set. As an example, the instruction set used by the Intel 80X86 processor family is incompatible with the instruction set used by the PowerPC processor family. The Intel 80X86 instruction set is based on the Complex Instruction Set Computer (CISC) format, while the Motorola PowerPC instruction set is based on the Reduced Instruction Set Computer (RISC) format. CISC processors use a large number of instructions, some of which can perform rather complicated functions, but which generally require many clock cycles to execute. RISC processors, on the other hand, use a smaller number of available instructions to perform a simpler set of functions that are executed at a much higher rate.

The uniqueness of the processor family among computer systems also typically results in incompatibility among the other elements of hardware architecture of the computer systems. A computer system manufactured with a processor from the Intel 80X86 processor family will have a hardware architecture that is different from the hardware architecture of a computer system manufactured with a processor from the PowerPC processor family. Because of the uniqueness of the processor instruction set and a computer system's hardware architecture, application software programs are typically written to run on a particular computer system running a particular operating system.

When updating hardware architectures of computer systems, such as game consoles to implement faster, more feature rich hardware, developers are faced with the issue of backwards compatibility to the legacy computer system for application programs or games developed for the legacy computer system platform. In particular, it is often commercially desirable that the updated hardware architecture support application programs or games developed for the legacy hardware architecture. However, if the updated hardware architecture differs substantially from that of the legacy hardware architecture (e.g., 80X86 vs. PowerPC), architectural differences between the two systems may make it very difficult, or even impossible, for legacy application programs or games to operate on the new hardware architecture without substantial hardware modification and/or software patches. Since customers generally expect such backwards compatibility, a solution to these problems aids in the success of the updated hardware architecture.

Recent advances in PC architecture and software emulation have provided hardware architectures for computers, even game consoles, that are powerful enough to enable the emulation of legacy application programs or games in software rather than hardware. Such software emulators translate the title instructions for the application program or game on the fly into device instructions understandable by the new hardware architecture. This software emulation approach is particularly useful for backwards compatibility for computer game consoles since the developer of the game console maintains control over both the hardware and software platforms and is quite familiar with the legacy games.

However, the Intel 80X86 uses a little-endian byte order, whereas the PowerPC uses big-endian byte order. This means that the emulator must flip the byte order of data and opcode arguments as part of the translation process. Unfortunately, there is not an efficient way to do this, and because byte reversal is very common, it results in a considerably bloated emulated product. This adversely affects the performance of legacy applications that are run in an emulated mode.

### SUMMARY OF THE INVENTION

A JIT binary translator examines code to determine if a conversion from big-endian to little-endian can be omitted. For example, the conversion may be omitted when data is merely being loaded and stored. The conversion from big-endian to little-endian may also be omitted when storing certain constructs and numbers. A third example is loading of floating point values. If a conversion from big-endian to little-endian is performed, this could result in four instructions in PowerPC, seven if double precision. However, if floating point values are access consistently as big-endian, the result is only one PowerPC instruction. Optimizations, such as these result in a tighter emulated binary.

### BRIEF DESCRIPTION OF THE DRAWINGS

The systems and methods of the present invention are further described with reference to the accompanying drawings, in which:

FIG. 1 illustrates the relationship between the virtual memory of the legacy game system implemented in a virtual machine and the virtual memory of the host game system;

FIG. 2 illustrates a system for converting x86 code from the legacy game system implemented in the virtual machine to PPC code of the host game system using the techniques of the invention;

FIG. 3 illustrates a flow chart of the operation of the JIT binary translator of the invention; and

FIG. 4 is a block diagram of an exemplary non-limiting multimedia/gaming device.

### DETAILED DESCRIPTION OF ILLUSTRATIVE EMBODIMENTS

A software emulator, described below, grabs an entire x86 function out of the source stream, rather than an instruction, translates the whole function into an equivalent function of the target processor, and executes that function all at once before returning to the source stream, thereby reducing context switching. In addition, to reduce the need for endian reversal, a translation engine reviews segments of code and selectively omits byte reversal under certain pre-defined circumstances, which will be described below in greater detail. By selectively omitting byte reversal, the total number of opcodes in the emulated product can shrink and the emulated product becomes more efficient

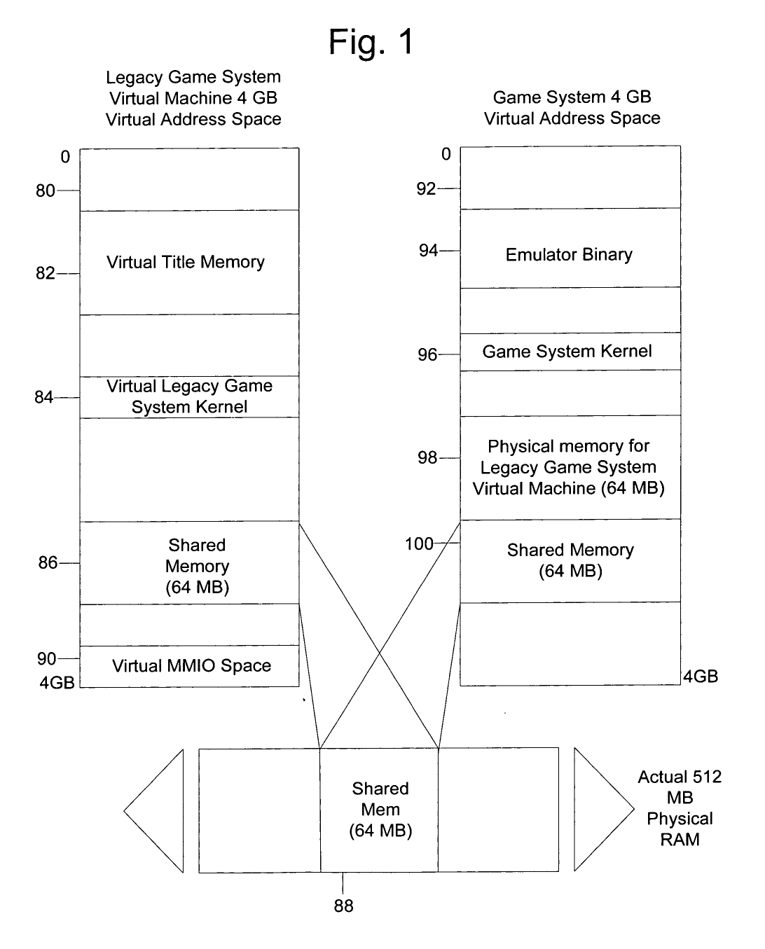

The present invention relates to features of a system that uses a software emulator to virtualize a legacy game system platform, such as Xbox, on a host game system platform that is an upgrade of the legacy game system platform. The software emulator enables the host game system platform to run legacy games in a seamless fashion. A software emulator with a just-in-time translation engine that translates the code at a function level and optimizes the translation so as to improve code translation efficiency. The techniques of the invention will be described below with respect to FIGS. 1-3.

When a media loader of the host game system console receives media containing a legacy computer game and is asked by the operating system of the host game system to boot the legacy computer game, the media loader instead invokes the software emulator of the invention to provide backwards compatibility for the operation of the legacy computer game. The software emulator loads and runs the legacy computer game as a standard game with the same rights and restrictions as any native computer game of the host game system. At boot time, the software emulator requests that two physical memory chunks be reserved: a 64 MB segment to host the virtualized legacy computer game, and a 64 MB segment to provide a conduit between the virtual machine that implements the legacy computer game and host computer game system.

FIG. 1 illustrates the relationship between the virtual memory of the legacy game system implemented in a virtual machine and the virtual memory of the host game system. In this example, the legacy game system is assumed to be Xbox, available from Microsoft Corporation. As illustrated, the legacy Xbox game system is implemented in a virtual machine environment and assumes a virtual address space 80 of 4 GB is available. As illustrated, the legacy 4 GB virtual address space is assumed by the legacy Xbox game system to have a section of memory 82 dedicated to the virtual title of the inserted legacy game, a memory 84 dedicated to the virtual legacy Xbox kernel, a 64 MB shared memory 86 that maps directly to a 64 MB shared memory in a physical RAM 88 of the host game system, and a virtual MMIO address space 90 in the upper region of the 4 GB virtual address space. Those skilled in the art will appreciate that the MMIO address space 90 in the legacy Xbox game system contains pointers to the actual hardware devices that are called by the drivers of the Xbox game system console's operating system. The virtual address space accessed by the legacy Xbox game as implemented in the virtual machine environment is configured the same as the virtual address space in the native legacy Xbox game system environment, thus tricking the legacy Xbox game into thinking that it is operating in the native legacy Xbox game system environment.

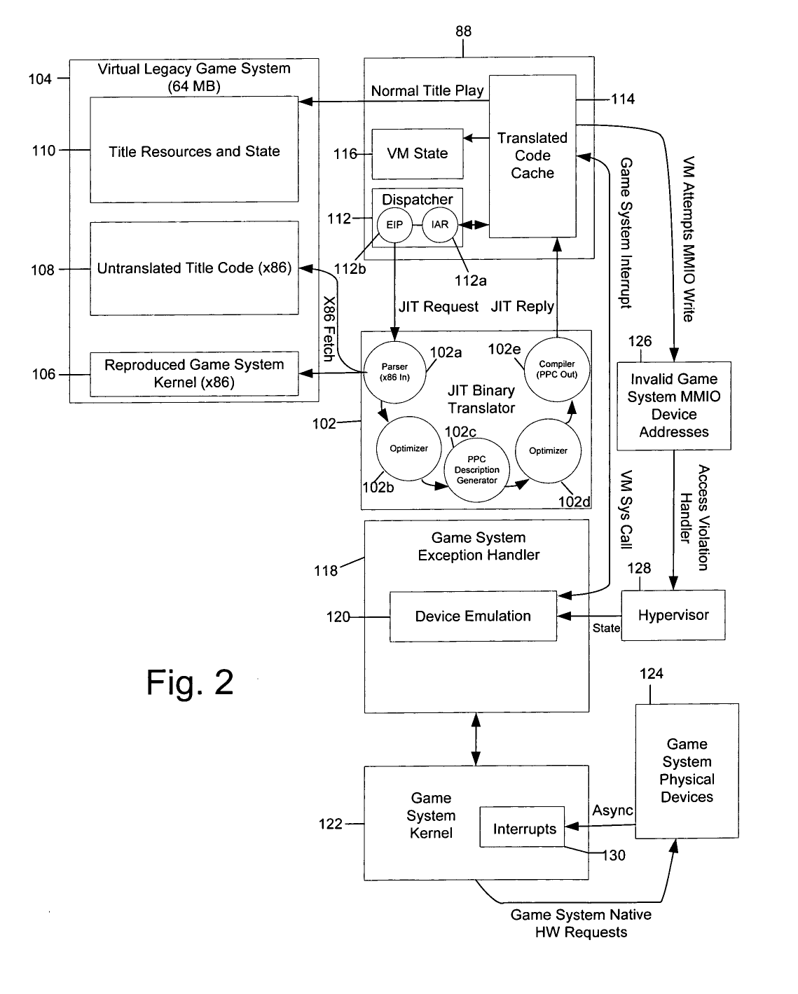

On the other hand, the virtual address space 92 of the native host Xbox game system is characterized by an emulator binary memory 94, the native host Xbox kernel 96, and a 64 MB physical memory segment 98 that hosts the legacy Xbox virtual machine. A 64 MB shared memory 100 is also provided that maps directly to the 64 MB shared memory in the physical RAM 88 of the native host Xbox game system. As will be explained in more detail below with respect to FIG. 2, a recreated copy of the x86 Xbox kernel 84 as well as the x86 title binaries originally passed to the game loader are loaded in the 64 MB space 98 reserved to the virtual Xbox game system. In the 64 MB shared memory space 100, on the other hand, the native host Xbox game system loads its dispatcher program, loads certain hand-optimized “glue” functions, and creates structures for virtual machine (VM) state and the translated code cache (FIG. 2). These functions are shared with the legacy Xbox game running on the virtual machine via shared memory 88, which is actually a physically shared section of RAM accessible to both the virtual machine implementing the legacy Xbox and the emulator engine of the native host Xbox operating system.

FIG. 2 illustrates a software emulation system for converting x86 code from the legacy game system implemented in the virtual machine to PPC code of the host game system using the techniques of the invention. As illustrated, the software emulation system of the invention includes four components:

a just-in-time (JIT) binary translator 102 that provides just-in-time binary translation of x86 code of the legacy Xbox game system to PPC code or other processor code of the native host Xbox game system;

a legacy Xbox virtual machine (VM) 104 that recreates most of the legacy Xbox environment in reproduced x86 Xbox kernel 106 and untranslated title code store 108 and the legacy title environment in stored title resources and state store 110;

a shared memory 88 that permits communication between the operating system of the native host Xbox game system and the VM 104 and hosts the dispatcher 112 and the translated code cache 114 while tracking VM state 116; and

an Xbox exception handler 118 that emulates the hardware devices of the native host Xbox system using device emulation 120 on the native Xbox kernel 122 for use by the Xbox VM 104 while running a legacy Xbox game.

After initialization of a legacy Xbox game in the legacy Xbox virtual machine 104, the operating system of the native host Xbox game system passes control to the dispatcher 112, which resides in the shared memory space 88. Fundamentally, the dispatcher 112 directs code execution for the virtualized legacy Xbox game. It maintains a mapping in a hash table between every x86 function referenced in the x86 space and an equivalent, translated PPC (or other host processor) function in the translated code cache 114. The job of the dispatcher 112 is to chain translated PPC (or other host processor) functions together in the sequence expected by the virtualized x86 legacy Xbox title. The first task of dispatcher 112 is to simulate booting the legacy x86 Xbox kernel 106 and legacy x86 title in title memory 110. If the host OS of the native host Xbox game system performs no significant pre-translation of emulated binaries, at first the dispatcher 112 has no cached PPC (or other host processor) equivalents for the requested x86 functions. To fill these gaps, the dispatcher 112 calls to the JIT binary translator 102 for just-in-time function translation.

Those skilled in the art will appreciate that translating x86 code to PPC code, for example, is problematic in some respects. For one thing, the x86 ISA contains several complex functions with no simple PPC ISA equivalents. For another, the PPC processor of the native host Xbox game system may be configured to interpret data as Big-Endian, whereas legacy Xbox titles expect Little-Endian interpretation. In addition, naive translation of legacy Xbox x86 code can result in a huge magnification of instructions and cache misses on the native host Xbox system hardware. The JIT binary translator of the invention takes steps to mitigate this “translation bloat” as will be described below.

As illustrated in FIG. 2, the JIT binary translator of the invention is implemented in five stages (102a, 102b, 102c, 102d, 102e), each of which will be described in turn.

Step 1: x86 Fetch and Parse. In step 102a, the JIT binary translator 102 is invoked by the dispatcher 112 and handed an extended instruction pointer (EIP) 112b referencing x86 code in the 4 GB address space 80 of the virtual machine 104. In this first stage of binary translation, an address translation is performed to locate the corresponding memory address in the software emulator's own 4 GB virtual address space 92. The software emulator then parses the x86 function op-codes from the 4 GB address space 80 into a structure corresponding to the x86 code function. If the function should prove to be larger than the pre-allocated structure space in the virtual address space 92, then the JIT binary translator 102 will halt execution.

Step 2: x86 Code Optimization. Once the JIT binary translator 102 has loaded its target x86 function, it performs some initial optimizations in step 102b. Sequences of x86 code known to create PPC inefficiencies are flagged for future reference. For example, the optimizer makes a note of non-volatile store/load operations that do not require endian byte reversal.

Step 3: PPC Descriptor Generation. The optimizer hands its product to the JIT middle tier at step 102c, which performs a naive translation of the optimized x86 instructions into corresponding groups of PPC instructions. Typically, a single x86 instruction corresponds to multiple PPC instructions. Very complicated x86 instructions such as fsin are replaced by hand-coded PPC “glue” functions stored in the shared memory 88.

Step 4: PPC Binary Executable Optimization. In step 102d, the PPC binary executable (BE) optimizer takes the sequence of PPC instructions generated at step 102c and attempts to reduce the instruction count, cycle count, and likely cache miss rate as much as possible. Any “translation bloat” remaining in the PPC code after this stage can only be compensated by the speed of the CPU of the host computer system.

Step 5: PPC Compilation and Store. Lastly, in step 102e the JIT binary translator 102 maps the PPC descriptions into 32-bit PPC machine instructions. The entire translated function is stored in the translated code cache 114 in the shared memory 88, and the starting address of the function is stored as an instruction address register (IAR) 112a next to the original EIP 112b in a hash table of the dispatcher 112. This allows the software emulator to remember the mapping of input code blocks to translated code blocks so that recompiling the same code block can be avoided by checking the hash table of the dispatcher 112 before calling the JIT binary translator 102. Control is then ceded by the software emulator and the thread returns to the virtual machine 104.

When the virtual machine 104 resumes, the dispatcher 112 once again tries to map its desired EIP to an IAR. This time, the lookup is successful, and the dispatcher 112 jumps code execution to the named IAR. The desired PPC function corresponding to the one or more x86 instructions in the legacy Xbox command sequence executes, operating on resources within the 4 GB memory space of the legacy Xbox virtual machine (104). When the legacy Xbox virtual machine completes processing of the desired PPC function, control jumps back to the dispatcher 112 by way of an interrupt with a request for the next x86 function and the entire JIT binary translation cycle begins again. Since computer games are generally coded as enormous loops, after the initial few seconds of execution, most x86 functions have been translated and are present in the translated code cache 114 as optimized PPC code (or other processor code if the native host Xbox game system uses a different processor).

Those skilled in the art will appreciate that the JIT binary translator 102 is a just-in-time compiler that will not translate x86 functions into PPC code until the very moment those functions are needed. The techniques of the invention are designed to prevent perceived delays when the JIT binary translator 102 encounters a large function for the first time. A couple of options may be considered to address this problem:

Pre-compile larger functions in the binary. The software emulator could spend some time before booting the application program or game to identify problematic functions and compile them before game play begins. This would eliminate the perceived jitter, but would also mean longer boot delays.

Perform a two-stage compilation of some functions. The JIT binary translator 102 could skip performance optimizations for some functions in order to get them running more quickly. Another thread running on a secondary CPU could optimize the code in good time and then replace the op-codes in the code cache.

Device requests and system calls by the legacy Xbox game create exceptions when the virtualized legacy Xbox game wants to speak to the legacy Xbox hardware but is unaware that it is operating on the platform of the native host Xbox game system. As with many operating systems, in the legacy Xbox operating system, games communicate with most devices by writing to well-known Memory Mapped I/O (MMIO) locations. As illustrated in FIG. 1, these MMIO locations were, in the case of the Xbox operating system, in the upper region 90 of the 4 GB virtual memory space. An access control list (ACL) may be used to restrict and/or reduce page permissions (e.g., to read only or to no read or write) such that the virtual machine 104 implementing the legacy Xbox game lacks read and write privileges to these MMIO addresses in memory 90. As a result, when the legacy Xbox game running in the virtual machine 104 attempts to access its expected device memory 90, the host Xbox operating system detects invalid Xbox MMIO device addresses at 126 and halts the thread. A memory access violation message is sent to the hypervisor 128 which, in turn, passes VM state information to the Xbox exception handler 118 to resolve the memory access violation.

The memory access violation and any intentional system calls forwarded to the Xbox exception handler 118 by the hypervisor 128 are processed to determine the intended target device using the MMIO address provided in the MMIO write from the legacy Xbox game. Since memory access violations often indicate a virtual device request, the Xbox exception handler 118 may simply check the virtual machine state provided by the hypervisor 128 (from VM state register 116) and determine the intended target device. Control is then given to an appropriate Xbox device emulator 120 in the Xbox exception handler 118, which translates and relays the request of the virtual machine 104 to the appropriate functions of the Xbox kernel 122 or to native host Xbox libraries. Since it cannot be assumed that the native host Xbox system shares any hardware with the legacy Xbox system, simple instruction forwarding is not an option. Of course, if hardware is shared, then instruction forwarding may be used.

As illustrated in FIG. 2, some native hardware requests to Xbox physical devices 124, such as hard drive I/O, produce asynchronous callbacks in the form of device interrupts 130. When the native host Xbox kernel 122 receives such an interrupt, it halts the JIT binary translator 102 and supplies the interrupt data to an appropriate Xbox device emulator 120 in the Xbox exception handler 118 that, in turn, translates the reply and stores it in the shared memory space 88. Control is then returned to the virtual machine 104 by simulating a legacy Xbox interrupt so that the virtual machine 104 may handle the new data.

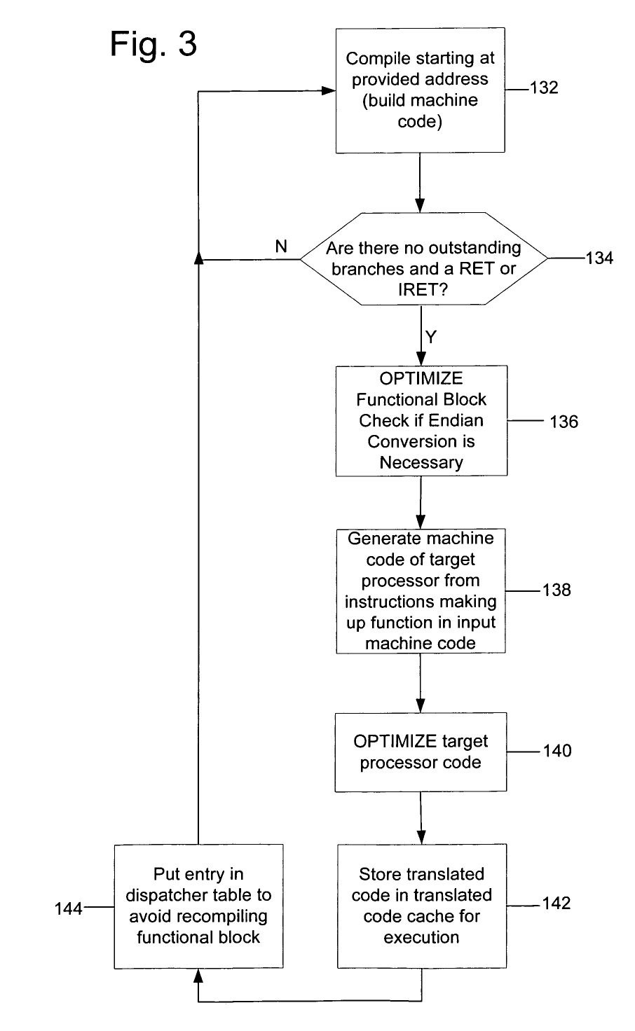

FIG. 3 illustrates the operation of the JIT binary translator 102. As illustrated, the JIT binary translator 102 starts compiling input source code at step 132 by starting at a provided address. The JIT binary translator 102 thus starts to build a stream of machine executable code for execution. The parser 102a of the JIT binary translator 102 identifies functions within the machine code at step 134 by recognizing code patterns and acting accordingly. For example, a source function may be defined as having a prolog, a body, and an epilog that together perform a task and return with processed variables. The prolog introduces the function and defines variables and the epilog ends the function to return control flow as appropriate and to return the variable values. Typically, the epilog is a RET or IRET function. On the other hand, the body includes code statements and conditions for executing other statements, including conditional branches, which may or may not be nested.

As illustrated in the above examples, the parser 102a treats the prolog, body, and epilog as one functional block. The block is identified by analyzing the code to identify the prolog and epilog and to identify branch operations. As illustrated at step 134, a function is known to be complete if there are no outstanding conditional branches when the epilog is reached. In other words, if RET or IRET is encountered by the parser 102a and no conditional branches are outstanding, then the JIT binary translator 102 knows that the end of the machine code function has been reached.

The resulting functional block of code provided by the parser 102a may be optimized at step 136 by optimizer 102b of the JIT binary translator 102 to improve processing efficiency. For example, the PowerPC processor is natively big-endian and data loaded in big-endian format requires one (or possibly a maximum of two) PowerPC instruction whereas the x86 is natively little-endian and data loaded in little format may require one or more (possibly up to 7) PowerPC instructions.

Thus, optimizations that may be performed by optimizer 102b include loading and storing data in big-endian format whenever possible and to avoid converting the data to little-endian format. This optimization results in less instructions that must be processed at run time. As the flow of instructions are analyzed, the conversion from big-endian to little-endian may also be omitted when storing certain constructs and numbers. For example, the number zero occurs often in little-endian. If a zero is stored big-endian (and not converted) it requires only one PowerPC instruction as opposed to two if it was converted to a little-endian representation. A third example is loading of floating point values. If a conversion from big-endian to little-endian is performed, this could result in four instructions in PowerPC, seven if double precision. However, if floating point values are access consistently as big-endian, the result is only one PowerPC instruction. One of ordinary skill in the art would now recognize that other conditions may exist that would benefit from the omission of endian conversion, and the above-identified conditions are not intended to be a limiting list of conditions.

Once the function has been identified and the code optimized, at step 138, the processor instructions making up the function in the input machine code are converted into machine code of the target processor (e.g., PowerPC from x86). Then, at step 140, the generated machine code is optimized by, for example, reducing the instruction count, cycle count, and likely cache miss rate as much as possible. The resulting optimized machine code for the target processor is stored in the translated code cache 114 for execution at step 142. Finally, at step 144, an entry is placed in the dispatcher hash table identifying the optimized code block so as to avoid recompiling the same functional block the next time it is encountered in the input code stream.

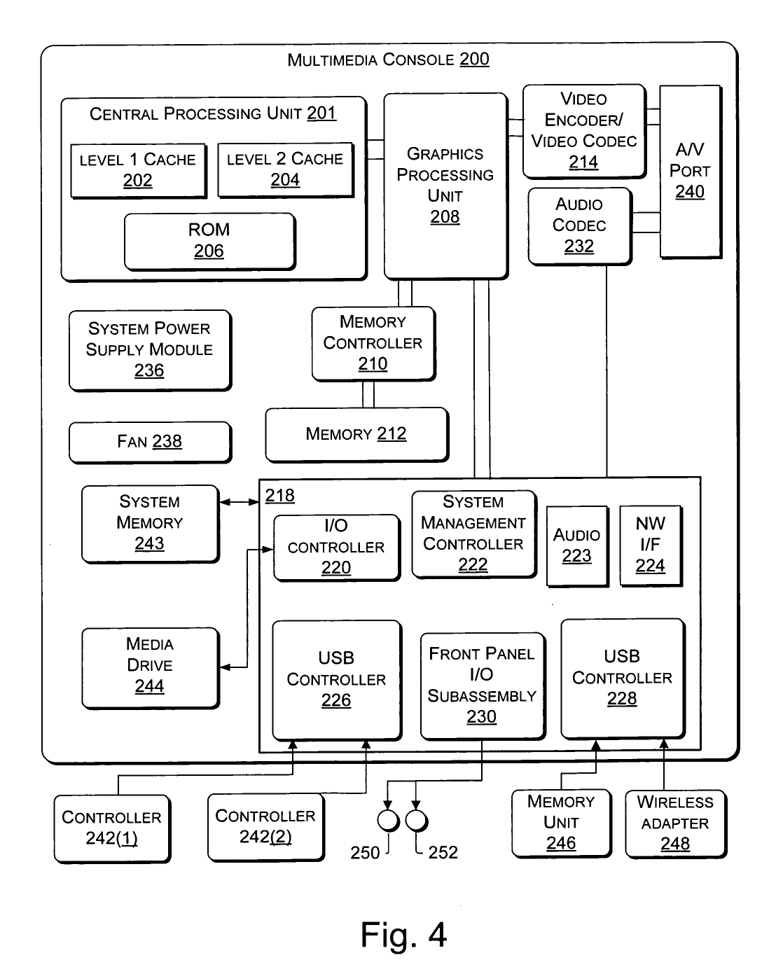

FIG. 4 illustrates the functional components of a multimedia/gaming console 200 in which certain aspects of the present invention may be implemented. The multimedia console 200 has a central processing unit (CPU) 201 having a level 1 cache 202, a level 2 cache 204, and a flash ROM (Read Only Memory) 206. The level 1 cache 202 and a level 2 cache 204 temporarily store data and hence reduce the number of memory access cycles, thereby improving processing speed and throughput. The CPU 201 may be provided having more than one core, and thus, additional level 1 and level 2 caches 202 and 204. The flash ROM 206 may store executable code that is loaded during an initial phase of a boot process when the multimedia console 200 is powered ON.

A graphics processing unit (GPU) 208 and a video encoder/video codec (coder/decoder) 214 form a video processing pipeline for high speed and high resolution graphics processing. Data is carried from the graphics processing unit 208 to the video encoder/video codec 214 via a bus. The video processing pipeline outputs data to an A/V (audio/video) port 240 for transmission to a television or other display. A memory controller 210 is connected to the GPU 208 to facilitate processor access to various types of memory 212, such as, but not limited to, a RAM (Random Access Memory).

The multimedia console 200 includes an I/O controller 220, a system management controller 222, an audio processing unit 223, a network interface controller 224, a first USB host controller 226, a second USB controller 228 and a front panel I/O subassembly 230 that are preferably implemented on a module 218. The USB controllers 226 and 228 serve as hosts for peripheral controllers 242(1)-242(2), a wireless adapter 248, and an external memory device 246 (e.g., flash memory, external CD/DVD ROM drive, removable media, etc.). The network interface 224 and/or wireless adapter 248 provide access to a network (e.g., the Internet, home network, etc.) and may be any of a wide variety of various wired or wireless adapter components including an Ethernet card, a modem, a Bluetooth module, a cable modem, and the like.

System memory 243 is provided to store application data that is loaded during the boot process. A media drive 244 is provided and may comprise a DVD/CD drive, hard drive, or other removable media drive, etc. The media drive 244 may be internal or external to the multimedia console 200. Application data may be accessed via the media drive 244 for execution, playback, etc. by the multimedia console 200. The media drive 244 is connected to the I/O controller 220 via a bus, such as a Serial ATA bus or other high speed connection (e.g., IEEE 1394).

The system management controller 222 provides a variety of service functions related to assuring availability of the multimedia console 200. The audio processing unit 223 and an audio codec 232 form a corresponding audio processing pipeline with high fidelity and stereo processing. Audio data is carried between the audio processing unit 223 and the audio codec 232 via a communication link. The audio processing pipeline outputs data to the A/V port 240 for reproduction by an external audio player or device having audio capabilities.

The front panel I/O subassembly 230 supports the functionality of the power button 250 and the eject button 252, as well as any LEDs (light emitting diodes) or other indicators exposed on the outer surface of the multimedia console 200. A system power supply module 236 provides power to the components of the multimedia console 200. A fan 238 cools the circuitry within the multimedia console 200.

The CPU 201, GPU 208, memory controller 210, and various other components within the multimedia console 200 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 200 is powered ON, application data may be loaded from the system memory 243 into memory 212 and/or caches 202, 204 and executed on the CPU 201. The application may present a graphical user interface that provides a consistent user experience when navigating to different media types available on the multimedia console 200. In operation, applications and/or other media contained within the media drive 244 may be launched or played from the media drive 244 to provide additional functionalities to the multimedia console 200.

The multimedia console 200 may be operated as a standalone system by simply connecting the system to a television or other display. In this standalone mode, the multimedia console 200 allows one or more users to interact with the system, watch movies, or listen to music. However, with the integration of broadband connectivity made available through the network interface 224 or the wireless adapter 248, the multimedia console 200 may further be operated as a participant in a larger network community.

When the multimedia console 200 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 200 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 201 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 242(1) and 242(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches.

The present invention is directed to a solution for conveying virtual controller ports (e.g., wireless controllers) as distinct from the two physical controllers 242(1) and 242(2). The present invention also addresses the need to inform players of messages and system notifications. To accomplish these goals and others, a wireless controller is provided that includes an LED indicator having quadrants that indicate a particular wireless controller, and a notification system that interacts with games running on the console 200.

Thus, the invention provides a mechanism whereby JIT binary translator may more efficiently translate instructions written for a first processor to instructions for a second processor based on the context of the received instructions. In particular, the binary translations are performed for functional blocks of code and optimized so as to speed up the binary translation operation. Such a JIT binary translator in accordance with the invention is particularly advantageous when used with programs or games running in a virtual machine environment where quick translations are critical to smooth operation. Those skilled in the art will appreciate that such techniques may be extended to all sorts of applications, not just game systems. Moreover, the techniques of the invention may be used to provide binary translations in other computer systems implementing software emulation techniques.

As mentioned above, while exemplary embodiments of the invention have been described in connection with various computing devices and network architectures, the underlying concepts may be applied to any computing device or system in which it is desirable to emulate guest software. For instance, the various algorithm(s) and hardware implementations of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the virtualization techniques of the invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the invention. Additionally, any storage techniques used in connection with the invention may invariably be a combination of hardware and software.

While the invention has been described in connection with the preferred embodiments of the various figures, it is to be understood that other similar embodiments may be used or modifications and additions may be made to the described embodiment for performing the same function of the invention without deviating therefrom. For example, while exemplary network environments of the invention are described in the context of a networked environment, such as a peer to peer networked environment, one skilled in the art will recognize that the invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the invention in the context of a guest OS virtualized on a host OS, the invention is not so limited, but rather may be implemented to virtualize a second specialized processing unit cooperating with a main processor for other reasons as well. Moreover, the invention contemplates the scenario wherein multiple instances of the same version or release of an OS are operating in separate virtual machines according to the invention. It can be appreciated that the virtualization of the invention is independent of the operations for which the guest OS is used. It is also intended that the invention applies to all computer architectures, not just the Windows or Xbox architecture. Still further, the invention may be implemented in or across a plurality of processing chips or devices, and storage may similarly be effected across a plurality of devices. Therefore, the invention should not be limited to any single embodiment, but rather should be construed in breadth and scope in accordance with the appended claims.

What is claimed:

1. A method of translating first computer executable code of a first CPU type to second computer executable code of a second CPU type, comprising:
examining a stream of said first computer executable code of said first CPU type to identify predetermined conditions;
omitting a conversion from a first byte order to a second byte order when said predetermined conditions exist; and
generating said sequence of second computer executable code of said second CPU type, said sequence of second computer executable code using said first byte order to access values in memory.

2. The method of claim 1, wherein said first CPU type is x86 and said second CPU type is PowerPC.

3. The method of claim 1, wherein said first byte order is big-endian and said second byte order is little-endian.

4. The method of claim 3, further comprising loading and storing data in big-endian format.

5. The method of claim 3, further comprising working with predetermined constructs and numbers in a big-endian format.

6. The method of claim 3, further comprising loading floating point values in big-endian format.

7. A binary translation engine that translates first computer executable code of a first CPU type to second computer executable code of a second CPU type, comprising:
a parser that examines a stream of said first computer executable code of said first CPU type to identify predetermined conditions; and
a code generator that omits a conversion from a first byte order to a second byte order when said predetermined conditions exist and generates said sequence of second computer executable code of said second CPU type, said sequence of second computer executable code using said first byte order to access values in memory.

8. The binary translation engine of claim 7, wherein said first CPU type is x86 and said second CPU type is PowerPC.

9. The binary translation engine of claim 7, wherein said first byte order is big-endian and said second byte order is little-endian.

10. The binary translation engine of claim 9, further comprising loading and storing data in big-endian format.

11. The binary translation engine of claim 10, further comprising working with predetermined constructs and numbers in a big-endian format.

12. The binary translation engine of claim 10, further comprising loading floating point values in big-endian format.

13. The binary translation engine of claim 10, wherein by omitting said conversion, said code generator generates said second computer executable instructions having fewer instructions than if said omitting was not performed.

14. A computer readable medium having computer executable code thereon for performing a binary translation of first computer executable code of a first CPU type to second computer executable code of a second CPU type, said computer executable code performing the method comprising:
examining a stream of said first computer executable code of said first CPU type to identify predetermined conditions;
omitting a conversion from a first byte order to a second byte order when said predetermined conditions exist; and
generating said sequence of second computer executable code of said second CPU type, said sequence of second computer executable code using said first byte order to access values in memory.

15. The computer readable medium of claim 14, wherein said first CPU type is x86 and said second CPU type is PowerPC.

16. The computer readable medium of claim 14, wherein said first byte order is big-endian and said second byte order is little-endian.

17. The computer readable medium of claim 16, further comprising instructions for loading and storing data in big-endian format.

18. The computer readable medium of claim 3, further comprising instructions for working with predetermined constructs and numbers in a big-endian format.

19. The computer readable medium of claim 3, further comprising instructions for loading floating point values in big-endian format.

20. The computer readable medium of claim 17, wherein by omitting said conversion, said second computer executable instructions have fewer instructions than if said omitting was not performed.
